(19) United States
(12) Patent Application Publication
(10) Pub. No.: US 2023/0005019 A1
(43) Pub. Date: Jan. 5, 2023

(54) METHODS, SYSTEMS, AND MEDIA FOR PROVIDING AUDIENCE RECOMMENDATIONS

(71) Applicant: Google LLC, Mountain View, CA (US)

(72) Inventors: Jane Huang, Seattle, WA (US); Ian Porteous, Mercer Island, WA (US); Surbhi Maheshwari, Mountain View, CA (US); Mayur Chaudhari, Fremont, CA (US); Tin Acosta, New York, NY (US)

(21) Appl. No.: 17/856,160

(22) Filed: Jul. 1, 2022

Related U.S. Application Data
(60) Provisional application No. 63/218,358, filed on Jul. 4, 2021.

(51) Int. Cl. G06Q 30/02

(52) U.S. Cl. CPC G06Q 30/0256; G06Q 30/0246

(57) ABSTRACT

Methods, systems, and media for providing audience recommendations are provided. In some embodiments, the method for providing content recommendations includes: receiving an indication that a user account has been authenticated; determining whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms; determining that a performance metric in response to applying the custom audience to the campaign is greater than a threshold performance metric; in response to determining that the campaign associated with the user account meets the one or more criterion, generating the recommendation interface that prompts the content provider to create the custom audience for application to the campaign, wherein the recommendation interface includes the performance metric and a plurality of suggested keywords for reaching the custom audience; and causing the recommendation interface to be presented.

### CROSS-REFERENCE TO RELATED APPLICATIONS

This application claims the benefit of U.S. Provisional Patent Application No. 63/218,358, filed Jul. 4, 2021, which is hereby incorporated by reference herein in its entirety.

### TECHNICAL FIELD

The disclosed subject matter relates to methods, systems, and media for providing audience recommendations. More particularly, the disclosed subject matter relates to determining whether to present an audience recommendation interface for a user account based on whether the user account has met particular criterion (e.g., has not previously created a custom intent audience, meets particular safety/sensitivity conditions, etc.) and based on whether a campaign associated with the user account has a predicted increase in conversions based on a custom intent audience being created and applied to the campaign, where the audience recommendation interface includes the predicted increase in conversions and a plurality of selectable keywords for creating the custom intent audience.

### BACKGROUND

Many media content sharing services provide media content (e.g., video content, audio content, etc.) to millions of users. Access to such media content presents opportunities for other content, such as advertisements, to be provided with the media content. That is, advertisers may want to identify particular media content or particular channels of media content that may be relevant to a product or entity that is being advertised.

It can be, however, difficult to identify relevant media content or relevant channels of media content. For example, it can be difficult to determine whether a particular channel of media content has an audience that is likely to be interested in particular products or services. In some cases, such determinations are made manually, which can be time and resource intensive.

Accordingly, it is desirable to provide new methods, systems, and media for providing audience recommendations.

### SUMMARY

Methods, systems, and media for providing content recommendations are provided.

In accordance with some embodiments of the disclosed subject matter, a method for providing content recommendations is provided, the method comprising: receiving, using a server that includes a hardware processor, an indication that a user account has been authenticated; determining, using the hardware processor, whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms; determining, using the hardware processor, that a performance metric in response to applying the custom audience to the campaign is greater than a threshold performance metric; in response to determining that the campaign associated with the user account meets the one or more criterion, generating, using the hardware processor, the recommendation interface that prompts the content provider to create the custom audience for application to the campaign, wherein the recommendation interface includes the performance metric and a plurality of suggested keywords for reaching the custom audience; and causing, using the hardware processor, the recommendation interface to be presented.

In some embodiments, the one or more criterion include determining whether the campaign associated with the content provider has a particular amount of traffic over a time period. In some embodiments, the campaign is a video action campaign that has not received traffic over the time period and wherein the campaign is associated with a bidding strategy to maximize the number of conversions or a targeted cost per acquisition.

In some embodiments, the one or more criterion include determining whether the user account is associated with one or more previously created custom audiences. In some embodiments, the recommendation interface is inhibited from being presented to the content provider in response to the one or more criterion including the determination that the user account is associated with the one or more previously created custom audiences.

In some embodiments, the one or more criterion include determining whether the user account is associated with one or more election certificates.

In some embodiments, the one or more criterion include determining whether the one or more promotional content items in the campaign are deemed to be unsafe.

In some embodiments, the one or more criterion include determining whether one or more websites associated with the user account of the advertising entity are deemed to contain sensitive content.

In some embodiments, the performance metric indicates an increase in a number of conversions and a decrease in cost per acquisition of a customer.

In some embodiments, the method further comprises determining a plurality of suggested keywords for creating the custom audience, wherein the recommendation interface is supplemented with the plurality of suggested keywords in response to selecting an interface in the recommendation interface to create the custom audience.

In accordance with some embodiments of the disclosed subject matter, a system for providing content recommendations is provided, the system comprising a hardware processor that: receives an indication that a user account has been authenticated; determines whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms; determines that a performance metric in response to applying the custom audience to the campaign is greater than a threshold performance metric; in response to determining that the campaign associated with the user account meets the one or more criterion, generates the recommendation interface that prompts the content provider to create the custom audience for application to the campaign, wherein the recommendation interface includes the performance metric and a plurality of suggested keywords for reaching the custom audience; and causes the recommendation interface to be presented.

In accordance with some embodiments of the disclosed subject matter, a non-transitory computer-readable medium containing computer executable instructions that, when executed by a processor, cause the processor to perform a method for providing content recommendations is provided, the method comprising: receiving an indication that a user account has been authenticated; determining whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms; determining that a performance metric in response to applying the custom audience to the campaign is greater than a threshold performance metric; in response to determining that the campaign associated with the user account meets the one or more criterion, generating the recommendation interface that prompts the content provider to create the custom audience for application to the campaign, wherein the recommendation interface includes the performance metric and a plurality of suggested keywords for reaching the custom audience; and causing the recommendation interface to be presented.

In accordance with some embodiments of the disclosed subject matter, a system for providing content recommendations is provided, the system comprising: means for receiving an indication that a user account has been authenticated; means for determining whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms; means for determining that a performance metric in response to applying the custom audience to the campaign is greater than a threshold performance metric; means for generating the recommendation interface that prompts the content provider to create the custom audience for application to the campaign in response to determining that the campaign associated with the user account meets the one or more criterion, wherein the recommendation interface includes the performance metric and a plurality of suggested keywords for reaching the custom audience; and means for causing the recommendation interface to be presented.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative process for providing audience recommendations in accordance with some embodiments of the disclosed subject matter.

FIGS. 2A and 2B show illustrative examples of a notification for accessing an audience recommendation interface in accordance with some embodiments of the disclosed subject matter.

FIGS. 3A and 3B show illustrative examples of an audience recommendation interface that can be presented to a content provider in accordance with some embodiments of the disclosed subject matter.

FIGS. 4A and 4B show illustrative examples of an interface for creating a custom audience in accordance with some embodiments of the disclosed subject matter.

FIG. 5 shows a schematic diagram of an illustrative system suitable for implementation of mechanisms described herein for providing audience recommendations in accordance with some embodiments of the disclosed subject matter.

FIG. 6 shows a detailed example of hardware that can be used in a server and/or a user device of FIG. 5 in accordance with some embodiments of the disclosed subject matter.

### DETAILED DESCRIPTION

In accordance with various embodiments, mechanisms (which can include methods, systems, and media) for providing content recommendations are provided.

A content provider, such as a brand content provider (e.g., a brand advertiser) may desire to match a content campaign with an audience. A content management platform can provide the content provider with an opportunity to identify an audience for receiving one or more promotional content items in a campaign. For example, the content management platform can present an audience management interface that provides the content provider with an opportunity to select a content campaign and provide input relating to one or more of: demographic criteria relating to a desired audience (e.g., a target age range of an audience of presented content items, a gender of an audience that a content provider desires to reach, a country in which an audience that a content provider desires to reach, and/or any other suitable demographic criteria), affinity criteria relating to a desired audience (e.g., interests and/or habits associated with an audience that a content provider desires to reach), in-market and life event information (e.g., information that an audience is actively researching or planning), remarketing information (e.g., interaction information relating to how a desired audience has interacted with the content provider), etc. In another example, the audience management interface can also provide the content provider with an opportunity to select a content campaign and create a custom audience in which the content provider can input user interests in the form of relevant keywords or phrases (e.g., users with a corresponding interest or purchase intention, users that have searched for one or more of these keywords or phrases on one or more platforms), uniform resource locators (URLs) that a desired audience member might visit (e.g., users that browse websites similar to the inputted URL), and application that a desired audience member has used (e.g., users that have downloaded and/or executed mobile applications on mobile devices that are similar to the inputted application).

In some embodiments, the mechanisms described herein can determine whether to present a recommendation interface that prompts the content provider to create a custom audience for a campaign of one or more promotional content items. For example, the recommendation interface can be a notification that indicates that a campaign of one or more promotional content items associated with a user account should create and apply a custom audience as the custom audience can enhance a performance metric of the campaign. In a more particular example, the recommendation interface can prompt the content provider having the user account to create a custom audience using one or more suggested keywords as the application of the custom audience to the campaign is predicted to increase the number of conversions while decreasing the cost per acquisition.

In some embodiments, in response to determining that a user account associated with the content provider has been authenticated, the mechanisms can determine whether a campaign associated with a user account is eligible for receiving the recommendation interface.

In some embodiments, the mechanisms can determine whether a custom audience, such as a custom intent audience, has already been created for the campaign. In continuing this example, in response to determining that a custom audience has already been created for the campaign, the mechanisms can inhibit the recommendation interface from being presented to the content provider having the user account.

In some embodiments, the mechanisms can determine whether the user account is associated with particular types of campaigns. For example, the mechanisms can determine whether the user account is associated with a video campaign that allows the content provider to reach an audience on a video sharing platform. In another example, the mechanisms can determine whether the user account is associated with a video campaign that allows the content provider to reach an audience on a video sharing platform in which the promotional content item includes a call-to-action button, a call-to-action headline, or any other suitable element that prompts a response to the promotional content item. In yet another example, the mechanisms can determine whether the user account is associated with a video campaign that allows the content provider to reach an audience on a video sharing platform and determine whether the video campaign has received a particular amount of traffic. In continuing this example, the mechanisms can determine that the video campaign is eligible for the recommendation interface in response to determining that the video campaign has not received any traffic over a particular time period (e.g., seven days).

In some embodiments, the mechanisms can determine whether a campaign associated with the user account has particular advertising channel type and a particular bidding strategy. For example, the mechanisms can determine that the user account is associated with a video campaign that is owned and operated by the content provider and that the video campaign is associated with a bidding strategy that sets bids to help the content provider obtain a maximum number of conversions at or below a set cost per action.

In some embodiments, the mechanisms can determine whether a campaign is associated with a policy certificate. For example, promotional content items associated with an election may be allowed to be presented in a particular geographic region if the content provider has been verified. In continuing this example, the mechanisms can inhibit the recommendation interface from being presented to the content provider in response to determining that promotional content items are associated with a policy certificate.

In some embodiments, the mechanisms can determine whether a campaign has one or more promotional content items that are deemed to be unsafe. For example, the mechanisms can filter video campaigns that are determined to include objectionable content, such as violence, pornography, objectionable language, animal abuse, and/or any other type of objectionable content, from being eligible for presenting the recommendation interface. In continuing this example, the mechanisms can inhibit the recommendation interface from being presented to the content provider in response to determining that the video campaign includes objectionable content or any other suitable content that is deemed as being unsafe.

In some embodiments, the mechanisms can determine whether the content provider is associated with websites that are deemed to be sensitive sites. For example, the mechanisms can filter video campaigns associated with a user account from being eligible for presenting the recommendation interface in which the user account of the content provider is determined to be associated with websites that are deemed to be sensitive sites, such as gambling-related websites, religion-related websites, health-related websites, etc. In continuing this example, the mechanisms can inhibit the recommendation interface from being presented to the content provider in response to determining that the video campaign of a content provider is associated with websites that are deemed to be sensitive sites.

It should be noted that any suitable criterion and any suitable combination of criterion can be used to determine whether the recommendation interface that prompts the content provider to create a custom audience for a campaign of one or more promotional content items should be presented.

In response to determining that a campaign of a content provider is eligible for presenting the recommendation interface and in response to determining that the application of a custom audience to a campaign is predicted to have a performance metric that is greater than a particular threshold (e.g., a predicted increase in the number of conversions with a predicted decrease in the cost per acquisition), the mechanisms can present a recommendation interface that prompts the content provider having the user account to create a custom audience.

In some embodiments, the recommendation interface can include a selectable interface for creating a custom audience. In some embodiments, the recommendation interface can include the predicted change in the performance metric upon application of a custom audience. For example, in addition to prompting the user to create a custom audience for application to a campaign, the recommendation interface can indicate a predicted change in one or more performance metrics upon application of the custom audience (e.g., a 74% higher conversion rate at a 12% lower cost acquisition, a 3.2% chance of increasing the conversion rate while decreasing the cost per acquisition, etc.).

In some embodiments, the recommendation interface can include one or more suggested keywords that, upon selection, can insert the suggested keyword as an input to create the custom audience. For example, in response to selecting a suggested keyword, the keyword can be used to creating an audience that fits the need of the campaign. In a more particular example, based on campaign goals and bidding strategy of a campaign, the mechanisms can interpret the selected keywords to choose an audience that is focused on reach, consideration, and/or performance. In continuing this example, rather than reaching a sports fan affinity audience, a running shoe entity may want to reach marathon runners instead. The shoe company entity can define this audience of marathon runners by entering and/or selecting keywords (e.g., a user-inputted keyword, a suggested keyword in the recommendation interface, etc.), a URL of websites with content about running, training schedules, marathons, marathon nutrition, etc., and/or applications that a marathon runner would be interested in or would have downloaded onto a mobile device (e.g., a running application, a fitness tracking application, etc.).

In some embodiments, the mechanisms can be applied to multiple user accounts that are associated with a content provider. For example, the mechanisms can determine that the content provider is associated with multiple user accounts (e.g., one account per product type or service type) and can generate the recommendation interface to prompt the content provider to create a custom audience for each of the multiple accounts. This can include creating one custom audience that can be applied to one or more of the multiple accounts. This can also include creating different custom audiences for each of the multiple accounts in response to determining that each campaign for each user account is eligible for receiving the recommendation interface.

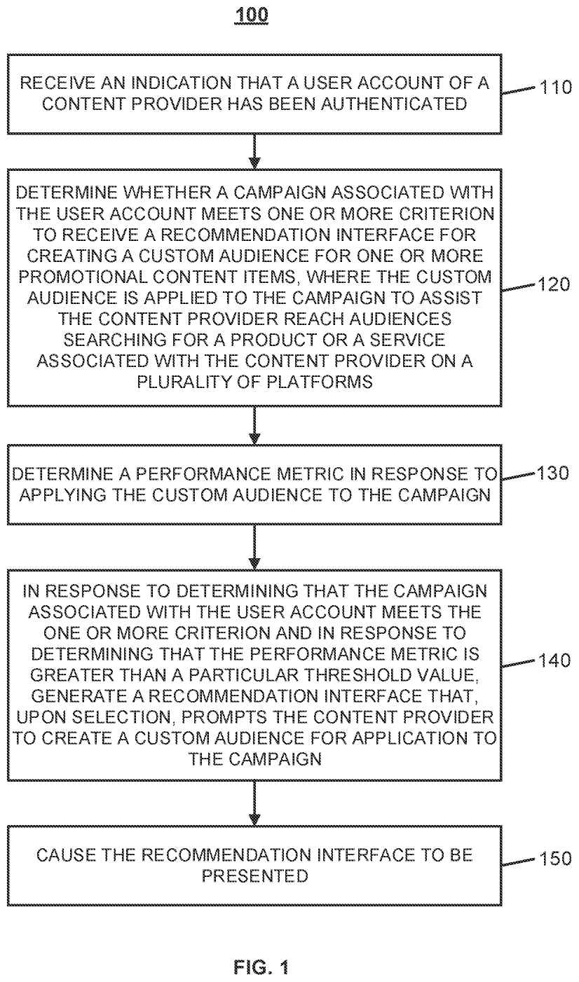

These and other features for providing audience recommendations are described further in connection with FIGS. 1-6.

Turning to FIG. 1, an illustrative example 100 of a process for determining whether to present an audience recommendation interface and for generating the audience recommendation interface for prompting the content creator to create a custom audience is shown in accordance with some embodiments of the disclosed subject matter. In some embodiments, blocks of process 100 can be executed by any suitable device, such as a server that hosts media content items and streams media content items to user devices. In some such embodiments, the server can execute blocks of process 100 to identify one or more campaigns of a user account corresponding to the content provider that is predicted to have an increase in one or more performance metrics in response to the application of a custom audience.

Process 100 can begin at 102 by receiving an indication that a user account associated with a content provider has been authenticated. For example, process 100 can receive an authentication request that includes user credentials for an audience management interface of a content management platform (e.g., usernames, passwords, and/or any other suitable user credentials). It should be noted that the user account can be the user account associated with a content management platform, the user account associated with an advertisement management platform, the user account that was used to proceed through the payment process in the advertisement management system, etc.

In some embodiments, the content provider can be associated with multiple user accounts. In response to authenticating a user account associated with the content provider, process 100 can determine whether additional user accounts are associated with the content provider and can include campaigns associated with the additional user accounts in determining eligibility for receiving the recommendation interface for creating custom audiences. Alternatively, in some embodiments, process 100 can determine that additional user accounts are associated with the content provider and can provide the content provider with an opportunity to select one or more of the user accounts to determine whether associated campaigns are eligible for receiving the recommendation interface for creating custom audiences.

In response to receiving an indication that a user account associated with a content provider has been authenticated, process 100 can determine whether a campaign associated with the user account meets one or more criterion to receive a recommendation interface for creating a custom audience for one or more promotional content items at 120. Such a custom audience can then be applied to the campaign to assist the content provider reach audiences searching for a product or a service associated with the content provider.

As described herein, the recommendation interface can be a notification that indicates that a campaign of one or more promotional content items associated with a user account should create and apply a custom audience to the campaign as the custom audience can enhance a performance metric of the campaign. For example, the recommendation interface can prompt the content provider having the user account to create a custom audience using one or more suggested keywords as the application of the custom audience to the campaign is predicted to increase the number of conversions while decreasing the cost per acquisition.

It should be noted that the custom audience can reach audiences searching for a product or a service associated with the content provider on multiple platforms. For example, one or more promotional content items can be provided to audiences that are searching for terms associated with a product or a service of the content provider (e.g., an advertiser) on a search engine site, a media sharing site, a streaming media platform, an application store, etc. It should be noted that these platforms may be owned and operated by the same entity.

It should also be noted that any suitable criterion and any suitable combination of criterion can be used to determine whether the recommendation interface that prompts the content provider to create a custom audience for a campaign of one or more promotional content items should be presented.

In some embodiments, process 100 can determine whether a custom audience, such as a custom intent audience, has already been created for the campaign. For example, in response to determining that a custom audience has already been created for the campaign, process 100 can inhibit or otherwise filter the recommendation interface from being presented to the content provider having the user account. In continuing this example, process 100 can ensure that a single custom audience has been created and assigned to each campaign of the content provider. Otherwise, in response to determining that a custom audience is not associated with a campaign of the content provider, process 100 can proceed to another criterion for determining whether the campaign is eligible for receiving a recommendation interface for the creation of a custom audience.

In some embodiments, process 100 can determine whether the user account is associated with particular types of campaigns. For example, process 100 can determine whether the user account is associated with a video campaign that allows the content provider to reach an audience on a video sharing platform (e.g., an “advertising_channel_type” tag having a value of “owned_and_operated” and/or an “advertising_channel_sub_type” tag having a value of “video_action”). In another example, process 100 can determine whether the user account is associated with a video campaign that allows the content provider to reach an audience on a video sharing platform in which the promotional content item includes a call-to-action button, a call-to-action headline, or any other suitable element that prompts a response to the promotional content item. In yet another example, process 100 can determine whether the user account is associated with a video campaign that allows the content provider to reach an audience on a video sharing platform and determine whether the video campaign has received a particular amount of traffic. In continuing this example, process 100 can determine that the video campaign is eligible for the recommendation interface in response to determining that the video campaign has not received any traffic over a particular time period (e.g., no traffic over the past seven days).

In response to determining that the campaign is not associated with a particular campaign type (e.g., the campaign is not a video campaign, the campaign has received more than a threshold amount of traffic over a particular time period), process 100 can inhibit or otherwise filter the recommendation interface from being presented to the content provider having the user account. Otherwise, in response to determining that the campaign is associated with a particular campaign type (e.g., the campaign is a video campaign, the campaign has received no traffic over a particular time period), process 100 can proceed to another criterion for determining whether the campaign is eligible for receiving a recommendation interface for the creation of a custom audience.

In some embodiments, process 100 can determine whether the campaign associated with the user account has a particular advertising channel type and/or a particular bidding strategy. For example, process 100 can determine that the user account is associated with a video campaign that is owned and operated by the content provider and that the video campaign is associated with a bidding strategy that sets bids to help the content provider obtain a maximum number of conversions at or below a set cost per action (e.g., a bidding strategy tag having a value of “max_conversions” or “target_CPA”).

In response to determining that the campaign is not associated with a particular advertising channel type and/or a particular bidding strategy, process 100 can inhibit or otherwise filter the recommendation interface from being presented to the content provider having the user account. Otherwise, in response to determining that the campaign is associated with a particular advertising channel type and/or a particular bidding strategy, process 100 can proceed to another criterion for determining whether the campaign is eligible for receiving a recommendation interface for the creation of a custom audience.

In some embodiments, process 100 can determine whether the campaign is associated with a policy certificate. For example, promotional content items associated with an election or other suitable political content may be allowed to be presented in a particular geographic region if the content provider has been verified. In continuing this example, process 100 can inhibit or otherwise filter the recommendation interface from being presented to the content provider in response to determining that the campaign is associated with a policy certificate. Otherwise, in response to determining that the campaign is not associated with a policy certificate, process 100 can proceed to another criterion for determining whether the campaign is eligible for receiving a recommendation interface for the creation of a custom audience.

In some embodiments, process 100 can determine whether a campaign has one or more promotional content items that are deemed to be unsafe. For example, process 100 can determine that one or more promotional content items within a campaign include offensive or inappropriate content, such as content that relates to violence and self-harm, harassment, racism, hatred and intolerance, and capitalizing on sensitive events or threatened species, etc. In a more particular example, process 100 can perform an image analysis of the content in the one or more promotional content items within the campaign to determine whether an image in the campaign includes offensive content, inappropriate content, or other content that is deemed as being unsafe. In another more particular example, process 100 can perform a text analysis of the content in the one or more promotional content items within the campaign to determine whether text in the campaign includes offensive content, inappropriate content, or other content that is deemed as being unsafe.

For example, process 100 can filter video campaigns that are determined to include objectionable content, such as violence, pornography, objectionable language, animal abuse, and/or any other type of objectionable content, from being eligible for presenting the recommendation interface. In continuing this example, process 100 can inhibit or otherwise filter the recommendation interface from being presented to the content provider in response to determining that the video campaign includes objectionable content or any other suitable content that is deemed as being unsafe.

In some embodiments, process 100 can determine whether the content provider is associated with websites that are deemed to be sensitive sites. For example, process 100 can determine that the user account is associated with a website owned by the content provider (e.g., the advertiser) that is considered to be a sensitive website (e.g., a gambling-related website, a religion-related website, a health-related website, etc.). In another example, process 100 can determine that a promotional content item leads to a website or a landing page that is considered to be a sensitive website.

In response to determining that the content provider is associated with websites that are deemed to be sensitive sites, process 100 can inhibit or otherwise filter the recommendation interface from being presented to the content provider having the user account. Otherwise, in response to determining that the content provider is not assigned with a website that is deemed to be a sensitive site, process 100 can proceed to another criterion for determining whether the campaign is eligible for receiving a recommendation interface for the creation of a custom audience.

It should be noted that any suitable criterion and any suitable combination of criterion can be used to determine whether the recommendation interface that prompts the content provider to create a custom audience for a campaign of one or more promotional content items should be presented. For example, in response to determining that the user account of the content provider has a campaign that is not associated with at least one custom audience, that is not associated with an election certificate, that is not associated with an unsafe creative, that is not associated with a website that is deemed to be sensitive, and that has not received any traffic within a particular time period, process 100 can determine that the campaign is eligible for receiving the recommendation interface to create a custom audience.

Referring back to FIG. 1, in some embodiments, process 100 can determine one or more performance metrics in response to applying a custom audience to the campaign at 130. For example, prior to presenting a recommendation interface to a content provider, process 100 can determine whether one or more performance metrics are enhanced by more than a threshold value in response to applying a custom audience to the campaign. In another example, process 100 can predict one or more performance metrics for the campaign in response to applying a custom audience to the campaign in order to provide the content provider with a reason to create a custom audience. In a more particular example, process 100 can determine a predicted change in one or more performance metrics upon application of the custom audience, such as a 74% higher conversion rate at a 12% lower cost acquisition or a 3.2% chance of increasing the conversion rate while decreasing the cost per acquisition.

It should be noted that, although the embodiments described herein include conversions and cost per acquisition as performance metrics, this is merely illustrative and any suitable performance metric can be used to determine whether to present a recommendation interface to a content provider. For example, the performance metrics can include a cost per impression (CPI) or cost per thousand impressions (CPM), where an impression may be counted, for example, whenever a content item is selected to be served for presentation with a resource. In some instances, the performance metric can include a click-through rate (CTR), defined as the number of clicks on the content item divided by the number of impressions. In some instances, the performance metrics can include a cost per engagement (CPE), where an engagement may be counted when a user interacts with the content item in a specified way. An engagement can be sharing a link to the content item on a social networking site, submitting an email address, taking a survey, and watching a video to completion. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics can be used. It should be noted that the various performance metrics can be measured before, during, or after content selection, content presentation, user click, or user engagement.

In some embodiments, process 100 can determine that a campaign associated with the user account is eligible for receiving the recommendation interface in response to determining that one or more performance metrics of the campaign upon application of the custom audience are predicted to increase by more than a threshold value.

Additionally or alternatively, process 100 can determine the one or more performance metrics of the campaign upon application of the custom audience and can include the one or more predicted performance metrics in the recommendation interface.

Referring back to FIG. 1, in some embodiments, process 100 can, at 140, generate a recommendation interface that prompts the content provider to create a custom audience for application to the eligible campaign in response to determining that the campaign associated with the user account meets the one or more criterion and/or in response to determining that the performance metrics of the campaign are predicted to increase by more than a threshold value upon applying the custom audience to the campaign.

In some embodiments, the recommendation interface can be generated in the form of a notification or any other suitable alert to the content provider. For example, in response to logging into a content management platform, a recommendation interface that prompts the user to create a custom audience can be presented in the form of a pop-up notification.

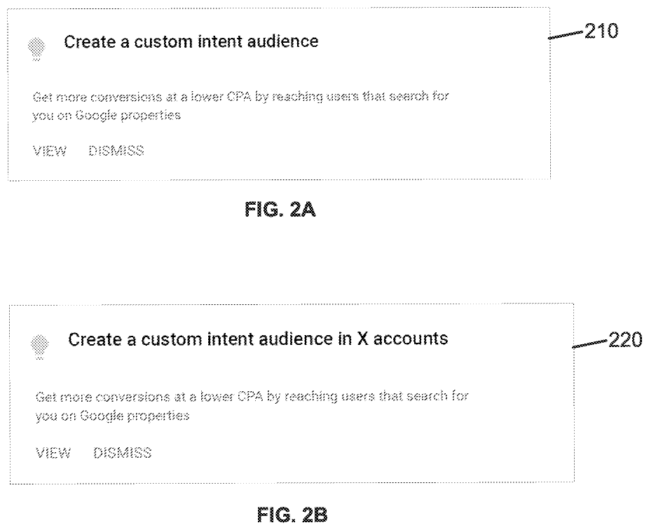

In a more particular example, FIG. 2A shows an illustrative example of a recommendation interface in the form of a notification that can be presented to the content provider. Turning to FIG. 2A, notification 210 can be presented within the interface of the content management platform and can indicate that creating and applying a custom audience to a campaign associated with the user account can increase conversions at a lower acquisition cost by reaching users that search for a product or a service of the content provider on multiple properties or platforms.

In some embodiments, a recommendation interface can be generated that indicates that application of a custom audience can increase the performance of campaigns of multiple user accounts that are associated with the content provider. For example, as described above, process 100 can determine that the content provider is associated with multiple user accounts in response to authenticating to a single user account. In continuing this example, process 100 can then determine that campaigns in each of these multiple user accounts are eligible for creating custom audiences. In response, process 100 can generate a notification indicating that campaigns in each of these multiple user accounts are eligible for creating custom audiences. For example, FIG. 2B shows an illustrative example of a recommendation interface in the form of a notification that can be presented to the content provider. Turning to FIG. 2B, notification 220 can be presented within the interface of the content management platform and can indicate that creating and applying a custom audience to campaigns in multiple accounts (e.g., X accounts) can increase conversions at a lower acquisition cost by reaching users that search for a product or a service of the content provider on multiple properties or platforms.

In some embodiments, the recommendation interface can be generated in the form of a card interface to the content provider. For example, in response to logging into a content management platform, a recommendation interface that prompts the user to create a custom audience can be presented in the form of a card interface.

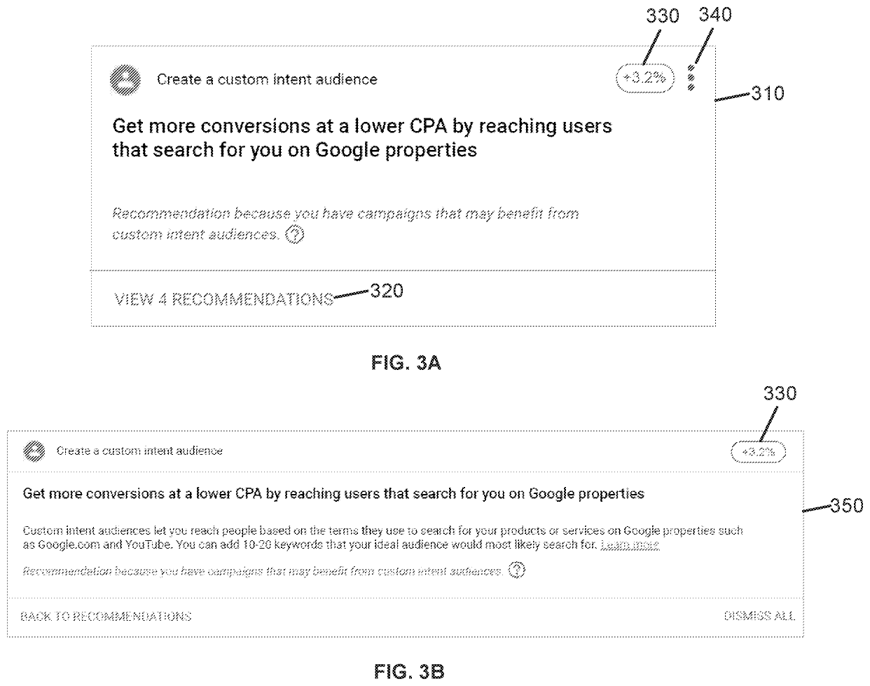

In a more particular example, FIG. 3A shows an illustrative example of a recommendation interface in the form of a card interface that can be presented to the content provider. Turning to FIG. 3A, a card interface 310 can be presented within the interface of the content management platform and can indicate that creating and applying a custom audience to a campaign associated with the user account can increase conversions at a lower acquisition cost by reaching users that search for a product or a service of the content provider on multiple properties or platforms. Additionally or alternatively, card interface 310 can be presented in a mobile application corresponding to the content management platform and can indicate that creating and applying a custom audience to a campaign associated with the user account can increase conversions at a lower acquisition cost by reaching users that search for a product or a service of the content provider on multiple properties or platforms.

It should be noted that card interface 310 can include any suitable reasons for prompting the content provider to create a custom audience. For example, as shown in FIG. 3A, card interface 310 can indicate that the recommendation interface was generated because the content provider has one or more campaigns that may benefit from creating a custom intent audience. In another example, card interface 310 can indicate that the recommendation interface was generated because the content provider has campaigns with a conversion goal or campaigns that use high-performing keywords to drive lower funnel actions.

In some embodiments, card interface 310 can include any suitable number of recommendations for creating a custom audience. For example, in some embodiments, card interface 310 can allow the content provider to input keywords, URLs, and/or applications relating to the audience that the one or more promotional content items in the campaign are intending to be reached. In another example, in some embodiments, card interface 310 can include one or more suggested keywords that, upon selection, can insert the suggested keyword as an input to create the custom audience. For example, in response to selecting a suggested keyword, the keyword can be used to creating an audience that fits the need of the campaign. In a more particular example, based on campaign goals and bidding strategy of a campaign, process 100 can interpret the selected keywords to choose an audience that is focused on reach, consideration, and/or performance. In continuing this example, rather than reaching a sports fan affinity audience, a running shoe entity may want to reach marathon runners instead. The shoe company entity can define this audience of marathon runners by entering and/or selecting keywords (e.g., a user-inputted keyword, a suggested keyword in the recommendation interface, etc.), a URL of websites with content about running, training schedules, marathons, marathon nutrition, etc., and/or applications that a marathon runner would be interested in or would have downloaded onto a mobile device (e.g., a running application, a fitness tracking application, etc.).

It should be noted that, in some embodiments, multiple recommendations can be provided for creating a custom audience to be applied to the campaign. For example, as shown in FIG. 3A, four recommendations can be presented within card interface 310 for selection by the content provider. In a more particular example, each recommendation can include a proposed custom audience, a proposed set of keywords, URLs, and/or applications that describe the audience that the campaign intends to reach.

In some embodiments, card interface 310 can include one or more performance metrics 330. For example, card interface 310 can include the predicted change in the performance metrics upon application of a custom audience to the campaign. For example, in addition to prompting the user to create a custom audience for application to a campaign, card interface can indicate a predicted change in one or more performance metrics upon application of the custom audience (e.g., a 74% higher conversion rate at a 12% lower cost acquisition, a 3.2% chance of increasing the conversion rate while decreasing the cost per acquisition, etc.).

It should be noted that, in some embodiments, process 100 can provide the content provider with the opportunity to indicate which performance metrics are important to the content provider. For example, in response to indicating that conversion rate is an important performance metric to the content provider, process 100 can generate card interface 310 with an indication as to the increase in conversion rate upon applying a custom audience to the campaign.

Referring back to FIG. 1, process 100 can cause the generated recommendation interface to be presented to the content provider at 150. For example, recommendation interface can be presented in the form of a notification, such as in FIGS. 2A and 2B, in the form of a card interface, such as in FIGS. 3A and 3B, or any suitable combination thereof.

In some embodiments, card interface 310 can be expanded to provide additional details for creating a custom audience. For example, as shown in FIG. 3A, in response to selecting element 340, an expanded card interface 350 can be presented to the content provider, such as the one shown in FIG. 3B. Turning to FIG. 3B, expanded card interface 350 can present the content provider with details for creating a custom audience—e.g., add ten to twenty keywords that an ideal audience would most likely search for.

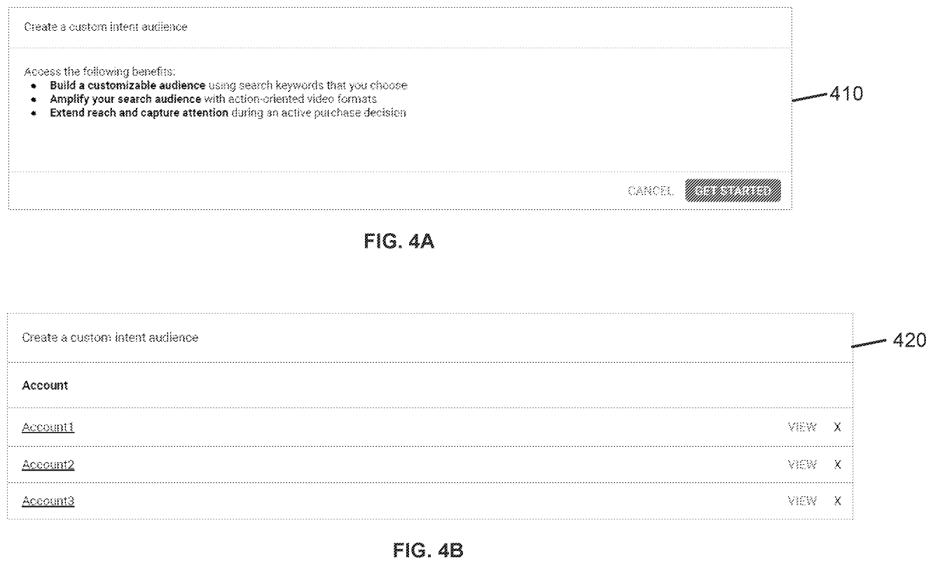

In some embodiments, in response to selecting the recommendation interface, process 100 can present an initial interface for creating a custom audience. For example, as shown in FIG. 4A, recommendation interface 410 can prompt the content provider to begin the process of creating a custom audience. In a more particular example, recommendation interface 410 indicates that the content provider can create a custom audience that uses search keywords selected by the content provider, that the content provider can amplify a search audience for the campaign with action-oriented video formats, that the content provider can extend reach and capture attention during an active purchase decision, etc.

In some embodiments, in response to selecting the recommendation interface, process 100 can prompt the user to create the custom audience by inputting and/or selecting keywords, URLs, and/or applications that describe the intended audience. For example, the recommendation interface can present an initial card with an empty audience and can allow the content provider to enter keywords, URLs, and/or applications that describe the intended audience.

In some embodiments, process 100 can present the user with suggested keywords for creating a custom audience for application to a campaign. For example, in some embodiments, in response to receiving keywords, URLs, and/or applications that have been inputted or selected by the content provider, process 100 can generate the suggested keywords based on the initial input. In a more particular example, in response to selecting a recommendation interface to create a custom audience, the recommendation interface can pre-populate with the suggested keywords. In response, the content provider can accept one or more of the suggested keywords by selecting one or more of the suggested keywords for inclusion in the custom audience.

In some embodiments, as described above, the recommendation interface can be generated that indicates that the application of a custom audience can improve the campaigns of multiple user accounts that are associated with the content provider. For example, process 100 can determine that the content provider is associated with multiple user accounts in response to authenticating to a single user account. In continuing this example, process 100 can then determine that campaigns in each of these multiple user accounts are eligible for creating custom audiences. In response, process 100 can generate a recommendation interface indicating that campaigns in each of these multiple user accounts are eligible for creating custom audiences. For example, FIG. 4B shows an illustrative example of a recommendation interface in the form of a card interface that can be presented to the content provider. Turning to FIG. 4B, a card interface 420 can be presented within the interface of the content management platform and can indicate that creating and applying a custom audience to campaigns in multiple accounts (e.g., X accounts) can increase conversions at a lower acquisition cost by reaching users that search for a product or a service of the content provider on multiple properties or platforms. In particular, card interface 420 can allow the content provider to select one or more user accounts for creating a custom audience.

Upon creating the custom audience, the content provider can be prompted to assign the custom audience to a campaign. In some embodiments, process 100 can monitor traffic and conversions to determine whether to adjust the performance metrics in additional recommendations to a user account.

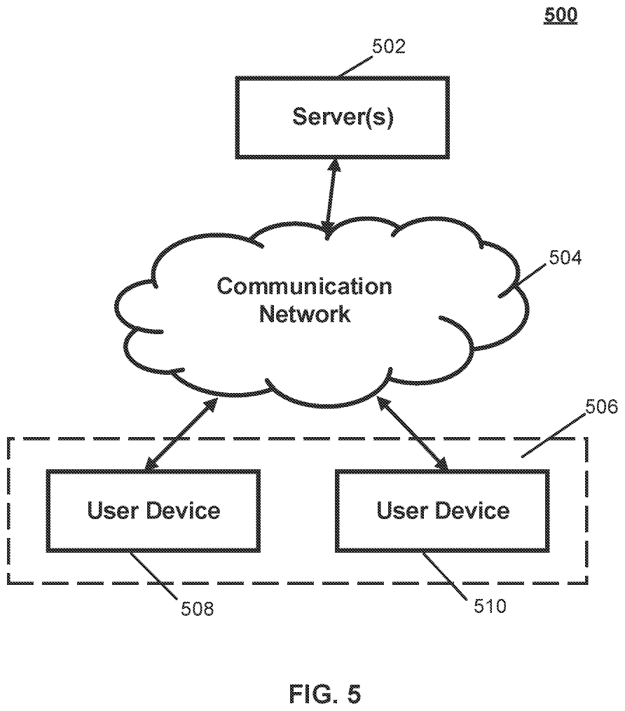

Turning to FIG. 5, an example 500 of hardware for identifying relevant content that can be used in accordance with some embodiments of the disclosed subject matter is shown. As illustrated, hardware 500 can include a server 502, a communication network 504, and/or one or more user devices 506, such as user devices 508 and 510.

In some embodiments, server 502 can be any suitable server for determine whether to generate and/or present a recommendation interface for creating a custom audience that can be applied to a campaign associated with a user account. For example, in some embodiments, server 502 can determine that a user account associated with the content provider has been authenticated, can determine that the campaign and/or the content provider are eligible for receiving the recommendation interface based on meeting one or more criterion, can determine one or more performance metrics upon applying the custom audience to the campaign, can generate a recommendation interface in the form of a card interface and/or a notification in response to determining that the campaign and/or the content provider are eligible for receiving the recommendation interface based on meeting one or more criterion, and presenting the recommendation interface that prompts the content provider to create a custom audience, as shown in and discussed above in connection with FIG. 1.

Communication network 504 can be any suitable combination of one or more wired and/or wireless networks in some embodiments. For example, communication network 504 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 506 can be connected by one or more communications links to communication network 504 that can be linked via one or more communications links to server 502. The communications links can be any communications links suitable for communicating data among user devices 506 and server 502, such as network links, dial-up links, wireless links, hard-wired links, any other suitable communications links, or any suitable combination of such links.

User devices 506 can include any one or more user devices suitable for receiving and transmitting parameters for content campaigns, presenting media content items, presenting advertisements, and/or for any other suitable purpose(s). For example, in some embodiments, user devices 506 can include a desktop computer, a laptop computer, a mobile phone, a tablet computer, and/or any other suitable type of user device.

Although server 502 is illustrated as one device, the functions performed by server 502 can be performed using any suitable number of devices in some embodiments. For example, in some embodiments, multiple devices can be used to implement the functions performed by server 502.

Although two user devices 508 and 510 are shown in FIG. 5 to avoid over-complicating the figure, any suitable number of user devices, and/or any suitable types of user devices, can be used in some embodiments.

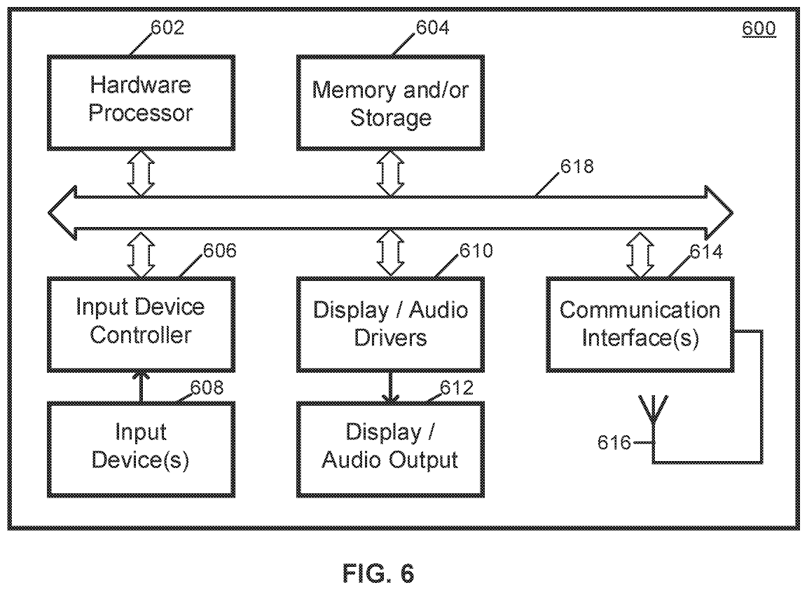

Server 502 and user devices 506 can be implemented using any suitable hardware in some embodiments. For example, in some embodiments, server 502 and user devices 506 can be implemented using any suitable general purpose computer or special purpose computer. For example, a mobile phone may be implemented using a special purpose computer. Any such general purpose computer or special purpose computer can include any suitable hardware. For example, as illustrated in example hardware 600 of FIG. 6, such hardware can include hardware processor 602, memory and/or storage 604, an input device controller 606, an input device 608, display/audio drivers 610, display and audio output circuitry 612, communication interface(s) 614, an antenna 616, and a bus 618.

Hardware processor 602 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 602 can be controlled by a server program stored in memory and/or storage of a server, such as server 502. In some embodiments, hardware processor 602 can be controlled by a computer program stored in memory and/or storage 604 of user device 506.

Memory and/or storage 604 can be any suitable memory and/or storage for storing programs, data, and/or any other suitable information in some embodiments. For example, memory and/or storage 604 can include random access memory, read-only memory, flash memory, hard disk storage, optical media, and/or any other suitable memory.

Input device controller 606 can be any suitable circuitry for controlling and receiving input from one or more input devices 608 in some embodiments. For example, input device controller 606 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 310 can be any suitable circuitry for controlling and driving output to one or more display/audio output devices 312 in some embodiments. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks (e.g., computer network 504). For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 504) in some embodiments. In some embodiments, antenna 316 can be omitted.

Bus 318 can be any suitable mechanism for communicating between two or more components 602, 604, 606, 310, and 314 in some embodiments.

Any other suitable components can be included in hardware 600 in accordance with some embodiments.

In some embodiments, at least some of the above described blocks of the processes of FIG. 1 can be executed or performed in any order or sequence not limited to the order and sequence shown in and described in connection with the figure. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for providing audience recommendations are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for providing content recommendations, the method comprising:
receiving, using a server that includes a hardware processor, an indication that a user account has been authenticated;
determining, using the hardware processor, whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms;
determining, using the hardware processor, that a performance metric in response to applying the custom audience to the campaign is greater than a threshold performance metric;
in response to determining that the campaign associated with the user account meets the one or more criterion, generating, using the hardware processor, the recommendation interface that prompts the content provider to create the custom audience for application to the campaign, wherein the recommendation interface includes the performance metric and a plurality of suggested keywords for reaching the custom audience; and
causing, using the hardware processor, the recommendation interface to be presented.

2. The method of claim 1, wherein the one or more criterion include determining whether the campaign associated with the content provider has a particular amount of traffic over a time period.

3. The method of claim 2, wherein the campaign is a video action campaign that has not received traffic over the time period and wherein the campaign is associated with a bidding strategy to maximize the number of conversions or a targeted cost per acquisition.

4. The method of claim 1, wherein the one or more criterion include determining whether the user account is associated with one or more previously created custom audiences.

5. The method of claim 4, wherein the recommendation interface is inhibited from being presented to the content provider in response to the one or more criterion including the determination that the user account is associated with the one or more previously created custom audiences.

6. The method of claim 1, wherein the one or more criterion include determining whether the user account is associated with one or more election certificates.

7. The method of claim 1, wherein the one or more criterion include determining whether the one or more promotional content items in the campaign are deemed to be unsafe.

8. The method of claim 1, wherein the one or more criterion include determining whether one or more websites associated with the user account of the advertising entity are deemed to contain sensitive content.

9. The method of claim 1, wherein the performance metric indicates an increase in a number of conversions and a decrease in cost per acquisition of a customer.

10. The method of claim 1, further comprising determining a plurality of suggested keywords for creating the custom audience, wherein the recommendation interface is supplemented with the plurality of suggested keywords in response to selecting an interface in the recommendation interface to create the custom audience.

11. A system for providing content recommendations, the system comprising:
a hardware processor that:
receives an indication that a user account has been authenticated;
determines whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms;
determines that a performance metric in response to applying the custom audience to the campaign is greater than a threshold performance metric;
in response to determining that the campaign associated with the user account meets the one or more criterion, generates the recommendation interface that prompts the content provider to create the custom audience for application to the campaign, wherein the recommendation interface includes the performance metric and a plurality of suggested keywords for reaching the custom audience; and
causes the recommendation interface to be presented.

12. The system of claim 11, wherein the one or more criterion include determining whether the campaign associated with the content provider has a particular amount of traffic over a time period.

13. The system of claim 12, wherein the campaign is a video action campaign that has not received traffic over the time period and wherein the campaign is associated with a bidding strategy to maximize the number of conversions or a targeted cost per acquisition.

14. The system of claim 11, wherein the one or more criterion include determining whether the user account is associated with one or more previously created custom audiences.

15. The system of claim 14, wherein the recommendation interface is inhibited from being presented to the content provider in response to the one or more criterion including the determination that the user account is associated with the one or more previously created custom audiences.

16. The system of claim 11, wherein the one or more criterion include determining whether the user account is associated with one or more election certificates.

17. The system of claim 11, wherein the one or more criterion include determining whether the one or more promotional content items in the campaign are deemed to be unsafe.

18. The system of claim 11, wherein the one or more criterion include determining whether one or more websites associated with the user account of the advertising entity are deemed to contain sensitive content.

19. The system of claim 11, wherein the performance metric indicates an increase in a number of conversions and a decrease in cost per acquisition of a customer.

20. The system of claim 11, wherein the hardware processor further determines a plurality of suggested keywords for creating the custom audience, wherein the recommendation interface is supplemented with the plurality of suggested keywords in response to selecting an interface in the recommendation interface to create the custom audience.

21. A non-transitory computer-readable medium containing computer executable instructions that, when executed by a processor, cause the processor to perform a method for providing content recommendations, the method comprising:
receiving an indication that a user account has been authenticated;
determining whether a campaign associated with the user account meets one or more criterion to receive a recommendation interface for creating a custom audience for one or more promotional content items in the campaign, wherein the custom audience is applied to a campaign to assist a content provider reach audiences searching for a product or a service associated with the content provider on a plurality of platforms;
determining that a performance metric in response to applying the custom audience to the campaign is greater than a threshold performance metric;
in response to determining that the campaign associated with the user account meets the one or more criterion, generating the recommendation interface that prompts the content provider to create the custom audience for application to the campaign, wherein the recommendation interface includes the performance metric and a plurality of suggested keywords for reaching the custom audience; and
causing the recommendation interface to be presented.
